(19) United States
(12) Patent Application Publication
(10) Pub. No.: US 2026/0168538 A1
(43) Pub. Date: Jun. 18, 2026

(54) BEARING ASSEMBLY WITH A BRUSH ASSEMBLY AND A DEVICE WITH A HOUSING AND A BEARING ASSEMBLY

(71) Applicants: AKTIEBOLAGET SKF, GOTEBORG (SE); SKF Aerospace France S.A.S, Perrigny (FR)

(72) Inventors: Benoit ARNAULT, Saint-Cyr-sur-Loire (FR); Franck GERVAIS, Bourg de Péage (FR)

(21) Appl. No.: 19/408,605

(22) Filed: Dec. 4, 2025

(30) Foreign Application Priority Data
Dec. 13, 2024 (DE) 102024137558.2

(51) Int. Cl. F16C 41/00; F16C 33/58

(52) U.S. Cl. CPC F16C 41/002; F16C 33/583; F16C 2202/32; F16C 2226/74

(57) ABSTRACT

A bearing assembly includes at least one bearing ring and a brush assembly. The brush assembly includes a flange and at least one brush fixed to the flange. The at least one bearing ring has a recess and the flange is fixed to the recess of the at least one bearing ring of the bearing assembly to attach the brush assembly with the bearing ring.

### CROSS-REFERENCE

This application claims priority to German patent application no. 102024137558.2 filed on Dec. 13, 2025, the contents of which are fully incorporated herein by reference.

### BACKGROUND OF THE INVENTION

The present invention relates to bearings, and more particularly to a bearing assembly with a brush assembly and a device including a housing and a bearing assembly.

German patent no. 10 2021 205 177 A1 discloses a bearing assembly with a brush assembly, which comprises a flange and a brush fixed to the flange. Moreover, German patent nos. 10 2021 203 004 A1 and 10 2021 205 176 A1 describe further bearing assemblies with brushes. Furthermore, Korean patent no. 20240066730A, European patent no. 4 446 602 Al and German patent no. 10 2023 110 736 Al each describe additional bearings, which each include conductive means for protecting the bearings from electrical current.

### SUMMARY OF THE INVENTION

An object of the present invention is to provide a bearing assembly with a compact and efficient construction. This object is solved according to the present invention, which in one aspect is a bearing assembly comprising a bearing ring having a recess and a brush assembly including a flange and at least one brush fixed to the flange. The flange is fixed to the recess of the bearing ring.

It is proposed that the flange is fixed to a bearing ring of the bearing assembly at least by means of a recess of the bearing ring. The term “flange” is intended to cover a projecting, particular radially or almost radially projecting, structure such as rim, collar, or edge used to connect, strengthen, and/or align components. The term “radial” is to be understand to refer to radial with respect to the bearing ring.

Thereby a compact and efficient construction can be achieved. In particular, a radial dimension of the bearing ring doesn't need to be extended for fixation of the flange and a recess, which can be produced very cost efficiently, can be used for the fixation of the flange.

In particular, the bearing ring can be an inner ring and/or an outer ring.

Preferably, the recess is located on a radially inner side of the bearing ring. Due to this recess location, an increase of an outer diameter of the bearing ring can be avoided.

Moreover, it is proposed that the bearing ring is an outer ring and at least one axial end of the recess has a radial distance from a radially most inner surface area of the outer ring, which is greater than zero. Thereby, a production price of the bearing ring is low. In particular, the bearing ring can be a ring, which is already produced in relatively large quantities. In particular, the bearing ring can be a ring with a groove, in which such a groove is used in other applications for fixing or attaching a seal.

Advantageously, the recess is a groove. Through this a cost efficient and stable fixation of the brush assembly can be reached. In particular, the bearing ring can be a standard outer ring of a deep groove ball bearing.

Moreover, it is suggested that the bearing ring is an outer ring and the groove includes a surface area, which is located or extends radially inwardly compared to a first axial end of the groove, wherein the brush assembly abuts against the surface area. Thereby a stable fixation of the brush assembly with respect to at least one axial direction of the bearing ring can be achieved. Furthermore, it is proposed that a first portion of the flange abuts against the surface area and a curved portion of the flange, which is directly connected to the first portion, abuts against a ground or base of the groove. Due to this structure, a simple and stable construction together with a very easy assembly and disassembly can be achieved.

In an advantageous embodiment of the invention, the brush assembly comprises at least one clip, which is located at least partially in the recess and which at least contributes to a fixation of the brush assembly to the bearing ring. Through this a simple and non-destructively detachable fixation of the brush assembly can be reached.

Furthermore, it is proposed that the brush assembly comprises a first part, which is integrally formed and which is fixed directly to the bearing ring, and a brush of the brush assembly is fixed directly to the first part. Thereby a simple construction can be achieved. Moreover, it is suggested that the first part comprises at least one fixation means, which is a clip and which contributes to a fixation of the brush to the first part and which is located on a side of the first part, which faces a bearing of the bearing assembly. Through this a contribution to a stable and robust fixation of the brush can be achieved. In particular the clip can be located at a safe place.

With advantage the brush assembly comprises a first part, which is fixed to the bearing ring, and at least a second part, which is fixed to the first part, and a conductive brush, which is fixed to the second part, wherein the first part abuts against a first side of the second part, which is a face side of the second part, wherein the first part abuts against a second side of the second part, which is located opposite to the first side. Through this it can be achieved that an assembly of the brush assembly can take place at a relatively great distance from a shaft, which is supported rotatably by the bearing assembly.

Advantageously the first part abuts against a face side of the bearing ring. Thereby, the first part can receive relatively large forces in at least one axial direction.

Moreover, a device with a housing and a bearing assembly as described above is suggested, wherein the brush assembly abuts against the housing. Through this a flow of current through the bearing ring can be reduced.

### BRIEF DESCRIPTION OF THE SEVERAL VIEWS OF THE DRAWINGS

Further advantages can be seen in the following description of the drawings. Different embodiments of the invention are shown in the drawings. The drawings, the description and the claims contain numerous features in combination. The skilled person will expediently also consider the features individually and combine them to form useful further combinations.

FIG. 1 shows a part of an axial section through a bearing assembly according to the invention;

FIG. 2 shows another part of an axial section through a bearing assembly according to the invention;

FIG. 3 shows a perspective view of the bearing assembly;

FIG. 4 shows a partially exploded view of the bearing assembly;

FIG. 5 shows a state during an assembly of the bearing assembly;

FIG. 6 shows a part of an axial section through a second embodiment of a bearing assembly according to the invention;

FIG. 7 shows another part of an axial section through the second embodiment;

FIG. 8 shows a perspective view of the second embodiment;

FIG. 9 shows a partially exploded view of the second embodiment;

FIG. 10 shows a state during an assembly of the second embodiment;

FIG. 11 shows a part of an axial section through a third embodiment of a bearing assembly according to the invention;

FIG. 12A shows a first perspective view of a brush assembly of the third embodiment;

FIG. 12B shows a second perspective view of the brush assembly of the third embodiment;

FIG. 13 shows a part of an axial section through a fourth embodiment of a bearing assembly according to the invention;

FIG. 14A shows a first perspective view of a brush assembly of the fourth embodiment; and

FIG. 14B shows a second perspective view of the brush assembly of the fourth embodiment.

### DETAILED DESCRIPTION OF THE INVENTION

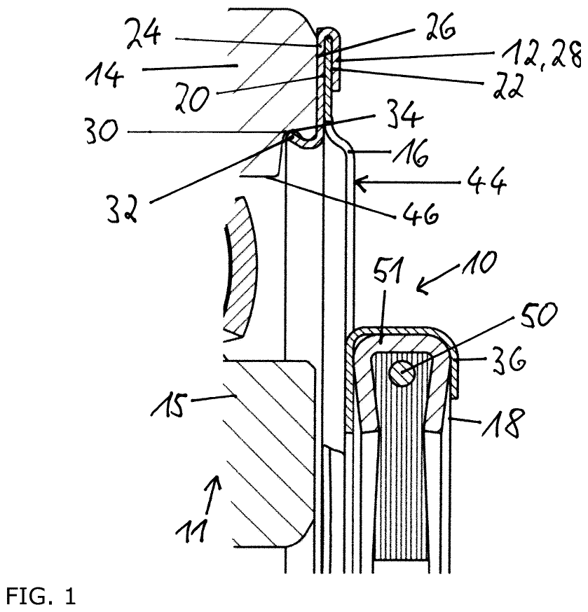

FIG. 1 shows a part of an axial section through a bearing assembly according to the invention, which comprises a bearing 11 and a brush assembly 10. A first bearing ring 14, which is an outer ring, and a second bearing ring 15, which is an inner ring, are part of the bearing 11 and are rotatable relative to each other around an axis (not shown). In the following description, the term “axial” refers to an axial direction with respect to the axis unless indicated otherwise. Also, in the following description, the term “radial” refers to a radial direction with respect to the axis unless indicated otherwise.

The bearing 11 is a rolling bearing with rolling elements, but could alternatively be a plain bearing. Moreover, the bearing 11 is preferably a deep groove ball bearing. However, the bearing 11 may include any other types of rolling elements, such as cylindrical rollers, tapered rollers, needles, spherical rollers, etc.

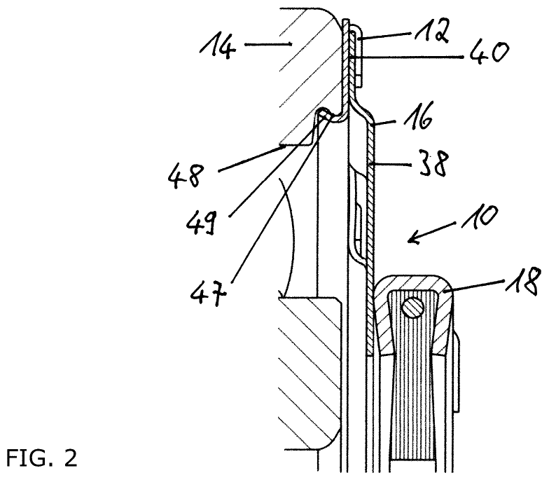

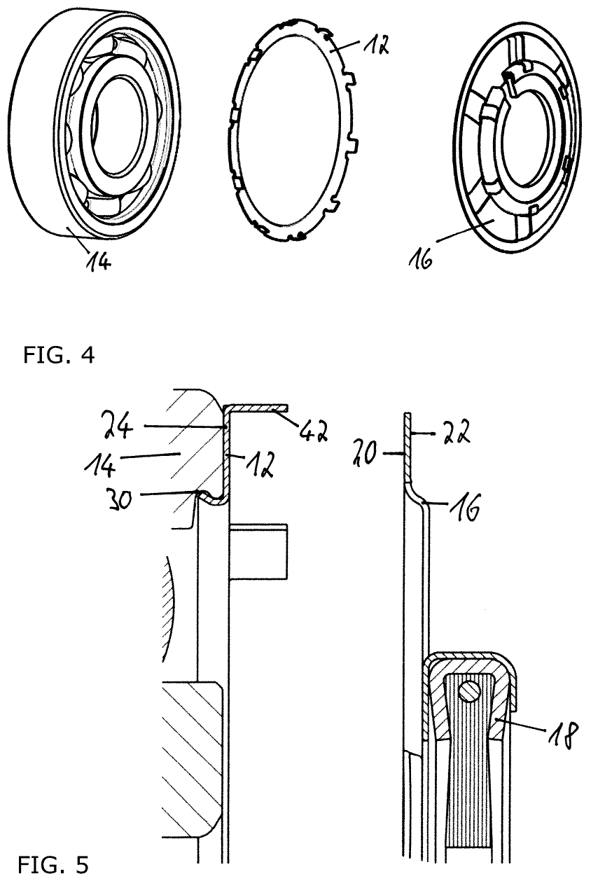

The brush assembly 10 includes a first part 12, a second part 16 and a conductive brush 18 (FIGS. 1-4), which is fixed to the second part 16. The second part 16 is fixed to the first part 12 and the first part 12 is fixed to the bearing ring 14. The bearing ring 14 has a recess 30, which is preferably located on a radially inner side 46 of the bearing ring 14 and which is formed as an annular groove, which extends in a shape of a ring around the axis of the bearing 11. An axial end 47 of the recess 30 has a radial distance from a radially-innermost surface area 48 of the bearing ring 14, which is greater than zero (FIG. 2).

A first radially-extending portion 24 of the first part 12, which extends radially in particular in an axial section of the bearing assembly, touches and abuts against a face side 26 of the bearing ring 14. The first radially extending portion 24 abuts against a first side 20 of the second part 16, which is a face side of the second part 16. A second radially-extending portion 28 of the first part 12, which extends radially in particular in an axial section of the bearing assembly and which adjoins the first radially extending portion 24, abuts against a second side 22 of the second part 16. The second side 22 is located opposite to the first side 20. Each one of the first part 12 and the second part 16 are made in one piece, i.e., are formed integrally, and preferably consist of sheet metal.

Each of the collar portion 32 and the portion 24 extend 360° around the axis of the bearing assembly. The portion 28 is preferably one of a plurality of portions of the first part 12, which are identical in construction with the portion 28 and which each abut against the second side 22. Alternatively, the other portions of the plurality of portions (i.e., those portions which are not the portion 28) can have a different shape than the portion 28. The plurality of portions have a circumferential distance from each other; in other words, are spaced circumferentially apart. Furthermore, the plurality of portions fix the second part 16 in a form-fit way to the first part 12.

The first part 12 is fixed in a form-fit way to the bearing ring 14 by means of the recess 30 and by means of the collar portion 32 of the first part 12, which is preferably formed as a clip 49. The collar portion 32 extends into the recess 30 and touches or abuts against a surface 34 of the recess 30. Starting from the first radially-extending portion 24 of the first part 12, the collar portion 32 extends in an axial direction away from the second part 16 and is curved radially outwardly, such that an axial end of the collar portion 32, which faces away from the second part 16, touches the surface 34. The brush assembly 10 can be detached in a nondestructive way from the bearing 11 by pulling the brush assembly 10 axially away from the bearing ring 14, such that the axial end of the collar portion 32 bends radially inwardly and can be pulled out of the recess 30.

The second part 16 comprises a first radially-extending portion 38 and a second radially-extending portion 40, which is spaced an axial distance from the first radially-extending portion 38 and which is located radially outwardly from the first radially-extending portion. The first portion 38 and the second portion 40 are connected by a further or intermediate portion (not indicated), which extends both axially and radially. Together the further, intermediate portion, the portion 38, the portion 40 and the first part 12 provide a flange 44 of the brush assembly 10. Moreover, the second part 16 further includes a first fixation means 36, which is preferably formed as a clip and which contributes to a fixation of the conductive brush 18 to the second part 16; in other words, the fixation means 36 at least partially fixes the brush 18 to the second part 16. The first portion 38 has a greater radial extent than the first fixation means 36.

The conductive brush 18 includes a plurality of conductive filaments and has the shape of a ring segment, which is preferably almost an entire ring. The filaments can be fibers, such as carbon fibers, steel fibers, conductive polymer fibers etc. All the filaments of the conductive brush 18 are preferably fixed by a wire 50 to a carrier element 51 of the conductive brush 18. The carrier element 51 has also the shape of a ring segment. Moreover, the last-mentioned ring segment is also almost a ring. In an axial section (e.g., as shown in FIG. 1) the carrier element 51 is generally U-shaped, wherein ends or sides of the carrier element 51 are bent toward each other such that the ends/sides press the filaments of the conductive brush together, which results in a fixation of the filaments to the carrier element 51.

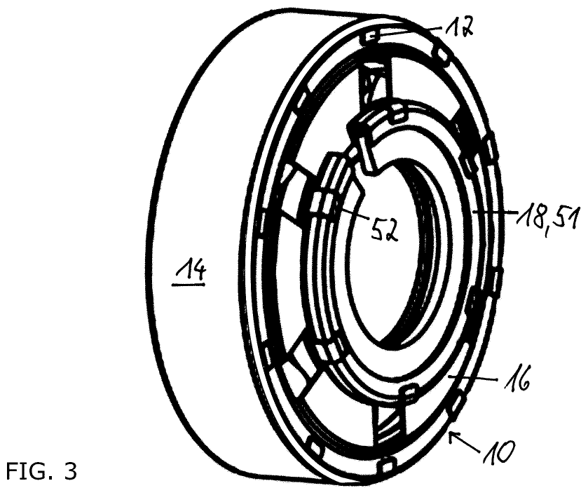

Further clips 52 (FIG. 3) of the second part 16 and the fixation means 36 are bent around the carrier element 51 such that the carrier element 51 is fixed to the second part 16 by clamping. The flange 44 has clearance holes (not indicated) located radially outwardly of the fixation means 36 and the further clips 52. In particular, these clearance holes allow the passage of oil through the brush assembly 10 both into and out of the bearing 11. The fixation means 36 and the further clips 52 are spaced from each other in a circumferential direction of the axis. Alternatively, the fixation means 36 and the further clips 52 can be omitted and the carrier element may be integrally formed with the first part 12. In total, the filaments of the conductive brush 18 are connected by the carrier element 51, the second part 16 and the first part 12 to the bearing ring 14 in an electrically conductive way.

In a procedure for assembling the bearing assembly, the first part 12 includes a portion 42 which initially extends in a longitudinal direction, which is parallel to an axial direction of the bearing ring 14, as shown in FIG. 5. The face side 20 of the second part 16 is brought into contact with the first part 12. Afterward, the portion 42 is bent radially inwardly such that it touches or abuts against the second part 16 on the opposing side 22 of the second part 16. After the portion 42 is bent, it is identical with the portion 28, which is then fixed to the second part 16. The plurality of portions of the first part 12, which may be identical in construction with the portion 28, are fixed to the second part 16 in the same manner as the portion 28.

The bearing ring 14 may be a standard bearing ring of a deep-grove ball bearing, which is already produced in very high numbers and is therefore available very cost-efficiently. The groove of such a standard bearing ring is typically provided for fixing a seal, which seals the space in which balls of the deep groove ball bearing are located. The bearing assembly can be part of a device in which the bearing 11 is immersed in or surrounded by oil such that a seal is not required.

The purpose of the conductive brush 18 is to prevent the passage of electrical current through the bearing 11.

Since the present bearing assembly is a single unit, instead of two units consisting of a separate brush assembly and bearing, only one unit has to be handled, for example by a purchaser of the bearing assembly.

Conductivity values of the brush and the brush assembly are the same or substantially equal.

Preferably, a thickness of the first part 12 and a thickness of the second part 16 are less than a thickness of a fixation part which typically fixes a brush directly in a housing. Therefore, a reduced weight is achieved by the brush assembly 10.

Moreover, stamping and cutting operations for producing the brush assembly 10 are as simple as for brush assemblies of the prior art. Furthermore, the bearing assembly according to the present invention uses minimal installation space in both axial and radial directions.

Preferably, an ingress chamfer (not indicated) is formed in the bearing ring 14 axially in front of the recess 30 such that the brush assembly 10 can be easily assembled to the bearing ring 14.

The brush 18 may contact a shaft (not shown), which is rotatably supported by the bearing 11, and/or the inner ring 15 and/or a part (e.g., a sleeve) fixed to the inner ring 15.

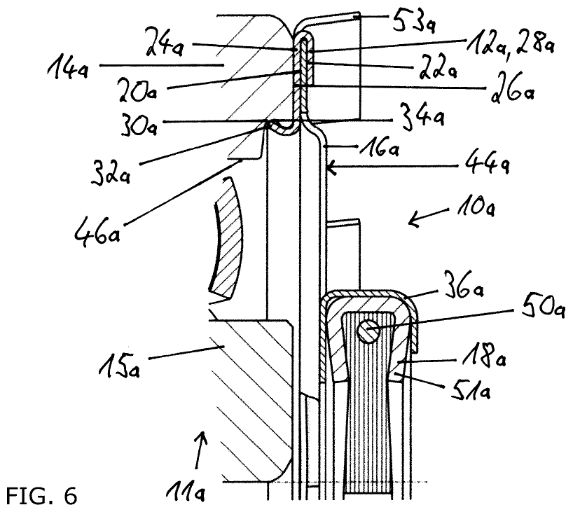

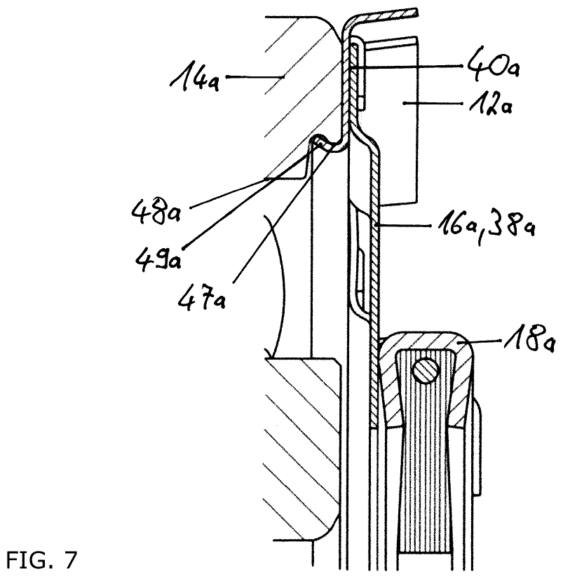

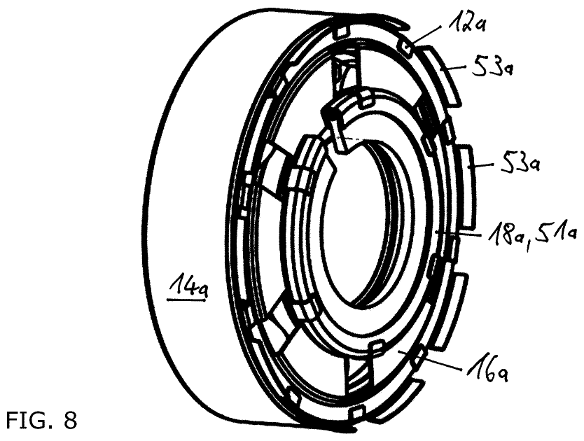

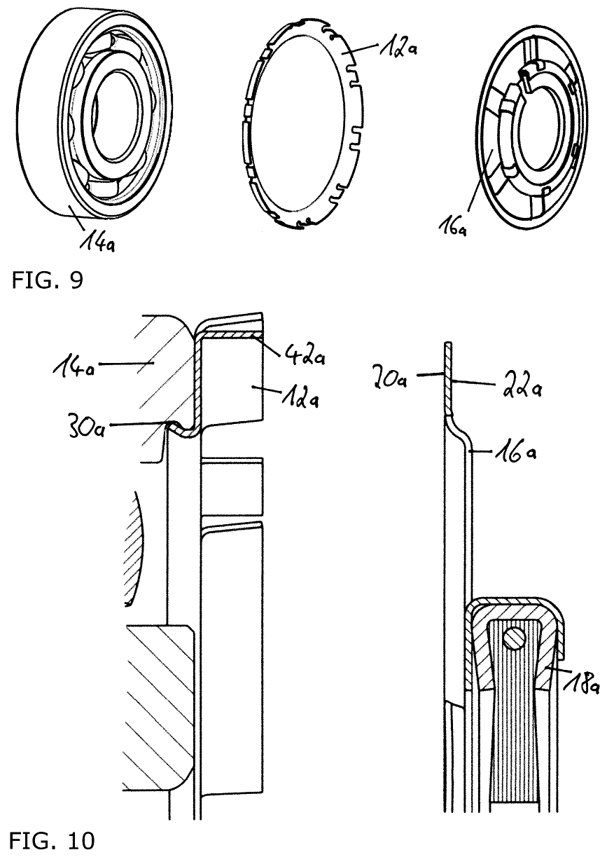

FIGS. 6-12B show alternative embodiments. Components, features and functions that are essentially the same are generally numbered with the same reference numerals. However, the letters “a”, “b” has been added to the reference numerals of the embodiments in FIGS. 6-12B to differentiate between the embodiments. The following description is essentially limited to the differences from the embodiment in FIGS. 1-5 described above, whereby reference can be made to the description of the embodiment in FIGS. 1-5 with regard to components, features and functions that remain the same.

The main difference between the embodiment of FIGS. 6-10 and the embodiment of the FIGS. 1-5 is that the first part 12a includes portions 53a which are located at a radially outer end of the first part 12a and which extend both axially and radially. When a bearing assembly of FIGS. 6-10 is a part of a device with a housing (not shown), the portions 53a can abut against the housing and can thereby create an electrically conductive connection or path between the first part 12a and the housing. Through this connection, electrical current can flow through a brush assembly 10a of the bearing assembly, such that a flow of electrical current from the housing through a bearing 11a can at least partially be avoided. The portions 53a are spaced from each other in a circumferential direction of the first part 12a. Further, the outer ring 14a of the bearing 11a does not need to be press fit within the housing.

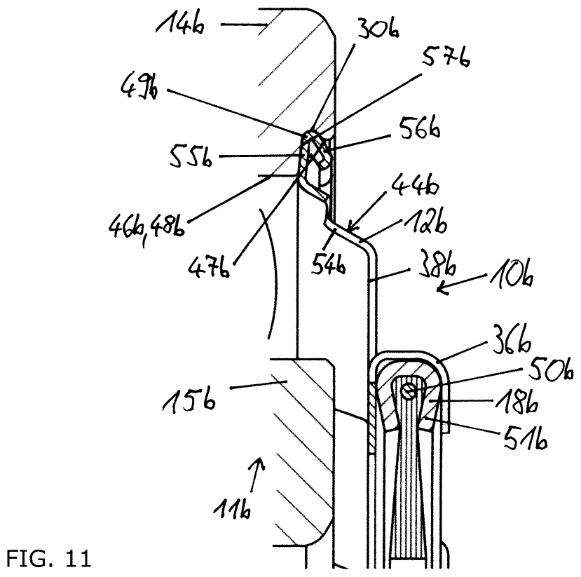

FIG. 11 shows an axial section through a third embodiment of a bearing assembly according to the present invention. The first part 12 and the second part 16 of the first embodiment are replaced by a first part 12b. The first part 12b includes a portion 38b and a clip 49b. Through the clip 49b, the first part 12b is fixed directly to a bearing ring 14b. A brush 18b is fixed directly to the first part 12b. The first part 12b is integrally formed and made in one piece. The clip 49b compromises a first portion 54b, a second portion 55b and a third portion 56b. The portion 54b extends axially and radially and connects the portion 55b with the portion 38b. In an axial section, the portion 55b is preferably straight, but may alternatively deviate from this shape.

A surface area 57b of a recess 30b is located radially inwardly compared to a first axial end 47b of the recess 30b. In the section the surface area 57b is a straight line. The portion 55b of the clip 49b abuts against the surface area 57b. The portion 56b is preferably straight in the axial section. Alternatively it may deviate from this shape. The portion 55b and the portion 56b are connected by a curved portion (not indicated) of the first part 12b, which is partially located in the recess 30b and which abuts against a base of the groove 30b. Through the curved portion, a form-fit fixation of the brush assembly 10b to the bearing ring 14b is realized. If an axial force is exerted on the brush assembly in a direction away from the bearing ring 14b, the clip 49b bends radially inwardly, such that the form-fit fixation is eliminated and the brush assembly 10b can be moved away from the bearing ring 14b. The curved portion extends 360° around a rotation axis of a bearing 11b of the bearing assembly.

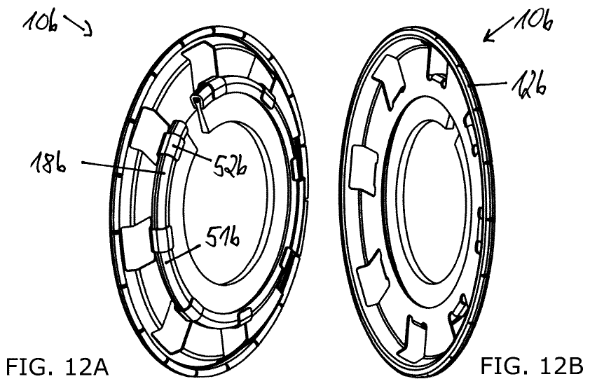

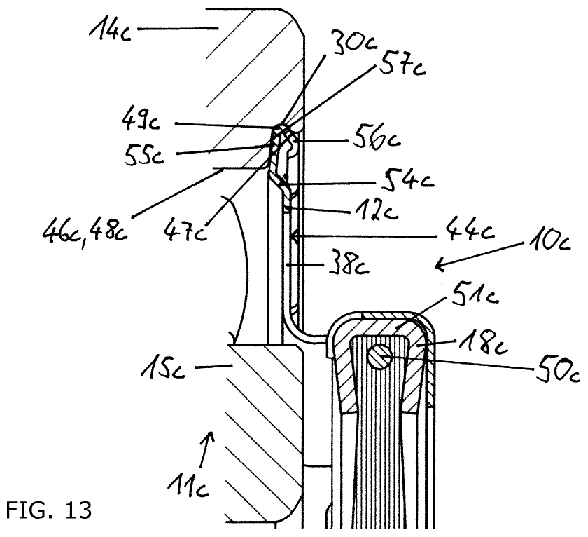

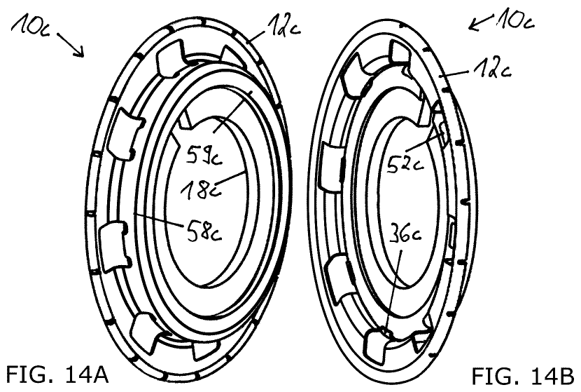

FIGS. 13-14B shows another alternative embodiment. Components, features and functions that are essentially the same are generally numbered with the same reference numerals. However, the letter “b” has been replaced by the letter “c” in the reference numerals of the embodiment in FIGS. 13-14B to differentiate between the embodiments. The following description is essentially limited to the differences to the embodiment in FIGS. 11-12B, whereby reference can be made to the description of the embodiment in FIGS. 11-12B with regard to components, features and functions that remain the same.

FIG. 13 shows an axial section through a third embodiment of a bearing assembly according to the invention. A first part 12c of a brush assembly 10c comprises a portion 38c from which a portion 58c extends axially away from a bearing 11c of the bearing assembly (FIG. 14A). Moreover, a portion 59c extends radially inwardly from an axial end of the portion 58c, which faces away from the bearing 11c. A carrier element 51c of the brush assembly 10c abuts against the portion 59c. Furthermore, a fixation means 36c and further fixation means of the first part 12c, which can be identical in construction with the fixation means 36c, clamp the carrier element 51c against the portion 59c and fix the carrier element 51c through this to the first part 12c. The fixation means 36c and the further fixation means are clips and are located on a side of the first part 12c, which faces the bearing 11c.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

List of reference numerals:

| | |
|---|---|
| 10 | brush assembly |
| 11 | bearing |
| 12 | part |
| 14 | bearing ring |
| 15 | bearing ring |
| 16 | part |
| 18 | brush |
| 20 | side |
| 22 | side |
| 24 | portion |
| 26 | face side |
| 28 | portion |
| 30 | recess |
| 32 | collar portion |
| 34 | surface |
| 36 | fixation means |
| 38 | portion |
| 40 | portion |
| 42 | portion |
| 44 | flange |
| 46 | side |
| 47 | end |
| 48 | surface area |
| 49 | clip |
| 50 | wire |
| 51 | carrier element |
| 52 | clip |
| 53 | portion |
| 54 | portion |
| 55 | portion |
| 56 | portion |
| 57 | surface area |
| 58 | portion |
| 59 | portion |

We claim:

1. A bearing assembly comprising:
a bearing ring having a recess; and
a brush assembly including a flange and at least one brush fixed to the flange, the flange being fixed to the recess of the bearing ring.

2. The bearing assembly according to claim 1, wherein the bearing ring has a radially inner side and the recess of the bearing ring is located on the radially inner side.

3. The bearing assembly according to claim 2, wherein the bearing ring is an outer ring having a radially-innermost surface area and the recess of the bearing ring has an axial end spaced from the radially-innermost surface area by a radial distance greater than zero.

4. The bearing assembly according to claim 1, wherein the brush assembly further includes at least one clip located at least partially within the recess and at least partially fixes the brush assembly to the bearing ring.

5. The bearing assembly according to claim 1, wherein the recess is a groove.

6. The bearing assembly according to claim 5, wherein the bearing ring is an outer ring and the groove includes a first axial end and a surface area extending radially inwardly with respect to the first axial end of the groove, the brush assembly abutting against the surface area of the groove.

7. The bearing assembly according to claim 6, wherein the flange of the brush assembly has a first portion abutting against the surface area of the groove and a curved portion directly connected to the first portion and abutting against a base of the groove.

8. The bearing assembly according to claim 1, wherein the brush assembly includes an integral first part fixed directly to the bearing ring and the brush of the brush assembly is fixed directly to the first part.

9. The bearing assembly according to claim 8, wherein the first part of the brush assembly includes at least one fixation means formed as a clip and which at least partially fixes the brush to the first part and is located on a side of the first part facing the bearing.

10. The bearing assembly according to claim 1, wherein the brush assembly includes a first part fixed to the bearing ring, at least one second part fixed to the first part, and a conductive brush fixed to the second part, the first part abutting against a first, face side of the second part and abutting against a second side of the second part located opposite to the first, face side.
